(19) United States
(12) Patent Application Publication
(10) Pub. No.: US 2007/0236606 A1
(43) Pub. Date: Oct. 11, 2007

(54) Methods and arrangements for accessing information via a graphical user interface

(76) Inventors: Aage Reerslev, Bromma (SE); Fredrik Berglund, Solna (SE)

Correspondence Address: KRISTOFER E. ELBING, 187 PELHAM ISLAND ROAD, WAYLAND, MA, 01778, US

(21) Appl. No.: 11/653,106

(22) Filed: Jan. 11, 2007

Related U.S. Application Data
(63) Continuation-in-part of application No. PCT/EP06/62134, filed on May 8, 2006.
(60) Provisional application No. 60/764,373, filed on Feb. 2, 2006.

(51) Int. Cl. H04N 5/44

(52) U.S. Cl. 348/562

(57) ABSTRACT

This application discloses, in one general aspect, a terminal, such as a mobile terminal, that accesses information elements, in which sub-areas are defined within a two-dimensional area of a display. Each of these sub-areas is associated with one of the information elements, and they can be organized according to a pattern. A content presentation area spans over the sub-areas and presents content that overlaps the sub-areas. The sub-areas can be organized in a manner that is substantially independent of a composition of the content.

This application claims the benefit of U.S. Provisional Application No. 60/764,373, filed Feb. 2, 2006. This application is also a continuation-in-part of International Application PCT/EP 2006/062134 with an international filing date of May 8, 2006. These documents are herein incorporated by reference.

### TECHNICAL FIELD

The present invention relates generally to methods and arrangements for accessing information, including methods and arrangements that can provide access to an extensive amount of information relative to screen size.

### BACKGROUND

A problem when providing access to a large numbers of information elements is that ordinary computer screens (or screens for mobile terminals such as cellular phones) can only display a limited number of information elements on one single screen picture. The user is therefore often required to scroll to access all of the available information. Numerous approaches to solving this problem have been proposed. These have focused on a variety of different ways to organize, display and access data. But, to date, none of these has achieved widespread acceptance and adoption.

### SUMMARY

In one general aspect, the invention features a terminal that accesses information elements, in which sub-areas are defined within a two-dimensional area of a display. Each of these sub-areas is associated with one of the information elements, and they are organized according to a pattern. A content presentation area spans over the sub-areas and presents content that overlaps the sub-areas.

In preferred embodiments, at least some of the sub-areas can remain visually differentiated despite the overlap of content in the content presentation area. At least some of the visually differentiated areas can be rendered with an attribute that corresponds to an attribute of the information elements that correspond to those areas. The pattern can be based on a grid that is regularly spaced in two directions. The grid can be a two-dimensional grid of squares. Pop-up display logic can be operative to display information describing one of the information elements corresponding to a selected one of the sub-areas, and content display logic can be operative to display in the presentation area at least part of one of the information elements corresponding to an actuation one of the sub-areas. Nested content display logic can be operative to display in the presentation area at least part of one of the information elements corresponding to an activated one of the sub-areas, with the displayed information element spanning over a plurality of sub-areas presented within a two-dimensional area of the display, and with these sub-areas being organized according to a pattern and associated with a second set of the information elements different from the first set. The terminal can be a mobile terminal. The terminal can be a mobile telephone. The terminal can be a personal computer. The terminal can be a Personal Data Assistant (PDA). The terminal can employ a television. The display can be a touch screen responsive to touch-based selection of the sub-areas. The terminal can further include a plurality of tab areas presented within the display. The terminal can further include a temporary storage area including further sub-areas. The terminal can include a user-downloaded program operative to define the sub-areas and present the content.

In another general aspect, the invention features a terminal that accesses information elements, in which sub-areas are defined within a two-dimensional area of a display. Each of these sub-areas is associated with one of the information elements. A content presentation area spans over the sub-areas and presents content that overlaps the sub-areas. The sub-areas are organized in a manner that is substantially independent of a composition of the content.

In a further general aspect, the invention features a method for making information elements available through a graphical user interface. This method includes the steps of presenting content in a two-dimensional display area, defining a plurality of sub-areas in the same two-dimensional area occupied by the content presented in the step of presenting, wherein the sub-areas are organized according to a pattern, and maintaining an association between the sub-areas and the information elements.

In preferred embodiments, the method can further include the steps of detecting activation of one of the sub-areas, retrieving information for at least one information element associated with the sub-area in response to the step of detecting, and presenting at least part of the information received in the step of receiving information in the same area used by the content presented in the step of presenting. The step of retrieving can take place from a remote content delivery system. The information elements can be acquired by the content delivery service from the internet. The acquired information elements can be translated into a format that enables their display as sub-elements. The information elements can be encoded in a compressed binary format. The compressed binary format can employ a block size that is smaller than its look-ahead buffer. A plurality of versions of the information elements can be prepared for different types of terminals having different display sizes. A plurality of the versions can be prepared and stored in advance of receipt of requests for the versions. Sets of user-defined associations between sub-areas and information elements for individual users can be made available on different types of terminals having different screen sizes. The step of detecting activation can detect selection of a sub-area, with the step of presenting information for the selected sub-area in a pop-up area. The method can further include the step of detecting actuation for the area for which selection was detected, with the step of presenting further information for the selected sub-area in response to the actuation.

In another general aspect, the invention features a method for making information elements available through a graphical user interface. This method includes presenting content in a two-dimensional display area, defining a plurality of sub-areas in the same area occupied by the content presented in the step of presenting, with the sub-areas being organized independently of a composition of the content, and maintaining an association between the each of the sub-areas and one of the information elements.

In a further general aspect, the invention features a memory for storing data for access by an application program being executed on a data processing system including a presentation area, which includes structured data stored in the memory. The structured data includes a plurality of information resource identifiers each associated with one of a plurality of sub-areas of the presentation area that are organized according to a regular pattern, and at least one content reference designating content to be displayed spanning over the plurality of sub areas.

In preferred embodiments, the structured data can be expressed as a tagged text document. The data structure can be expressed as an XML document. The structured data can further include at least one pattern attribute specifier designating an attribute of the regular pattern. The resource identifiers can each include a unique identifier and a link. The structured data can further include tab designators to define the function of tabs outside of the sub-areas. The structured data can further include descriptive content associated with at least some of the resource identifiers. The structured data can include a standalone structured data entity that includes resource identifiers for use independent of any screen size specification in that entity.

Embodiments of the invention can allow a user to access an extensive amount of information on a screen display without scrolling the screen. Providing for content displayed over a generally unrelated array of control areas allows embodiments of the invention maximize the use of space on a given screen, and can provide users with a pleasing and/or relatively familiar interface.

### BRIEF DESCRIPTION OF THE DRAWINGS

FIG. 1 is a web browser screen shot that illustrates a graphical user interface according to the present invention, showing access to a first information element;

FIG. 2 is a web browser screen shot that illustrates the graphical interface of FIG. 1, showing access to a second information element;

FIG. 3 is an illustration of a first mobile terminal employing a graphical user interface according to the present invention, showing access to a third information element (19×15 squares);

FIG. 4 is an illustration of a second mobile terminal employing a graphical user interface according to the present invention, showing access to a fourth information element (15×11 squares);

FIG. 5 is a diagram of an illustrative mobile terminal equipped with graphical user interface functionality according to the invention;

FIG. 6 is a block diagram of an illustrative content delivery system for different types of terminals, such as terminals equipped with browsers, as shown in FIGS. 1-2, or mobile terminals, as shown in FIGS. 3-5;

FIG. 7 is a flowchart illustrating the delivery of content by the system of FIG. 6 to the different types of terminals; and

FIG. 8 is a flowchart illustrating binary encoding of content sent to mobile terminals using the system of FIG. 6.

### DETAILED DESCRIPTION OF ILLUSTRATIVE EMBODIMENTS

In the following description of illustrative embodiments, for purposes of explanation and not limitation, specific details are set forth, such as particular sequences of steps, signaling protocols and device configurations in order to provide a thorough understanding of the present invention. It will be apparent to one skilled in the art that the present invention may be practiced in other embodiments that depart from these specific details.

Moreover, those skilled in the art will appreciate that the functions explained herein below may be implemented using software functioning in conjunction with a programmed microprocessor or general purpose computer, and/or using an application specific integrated circuit (ASIC). It will also be appreciated that while embodiments of the current invention are primarily described in the form of methods and devices, the invention may also be embodied at least in part in a computer program product as well as a system comprising a computer processor and a memory coupled to the processor, wherein the memory is encoded with one or more programs that may perform the functions disclosed herein.

In embodiments of the present invention, the display, or an area of the display is divided into a plurality of sub-areas, preferably tens of thousands sub-areas in the case of a larger display. The sub-area is typically a square of 10×10 pixels (but it can also be presented in other shapes such as circles or rhombuses). The sub-areas can be marked by a visual pattern, preferably a grid pattern, or any other suitable pattern, placed over a picture displayed on the display. The display may be an ordinary computer display or display of a mobile terminal such as a cellular phone. The display is connectable to processing means (e.g. a computer) whereby the processing means has access to a database, or another suitable storing means for storing information. A part of the storing means may be located remote from the device having the display and another part of the storing means may be located locally in the mobile terminal. The information elements of the storing means can be associated with different sub-areas, with each sub-area being preferably associated with an information element of the database or other suitable means for storing information.

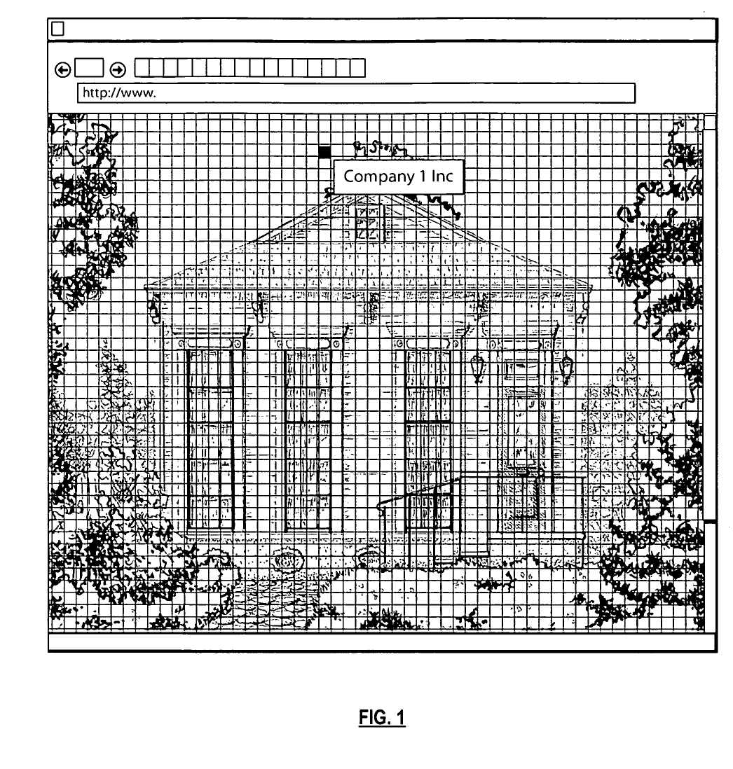

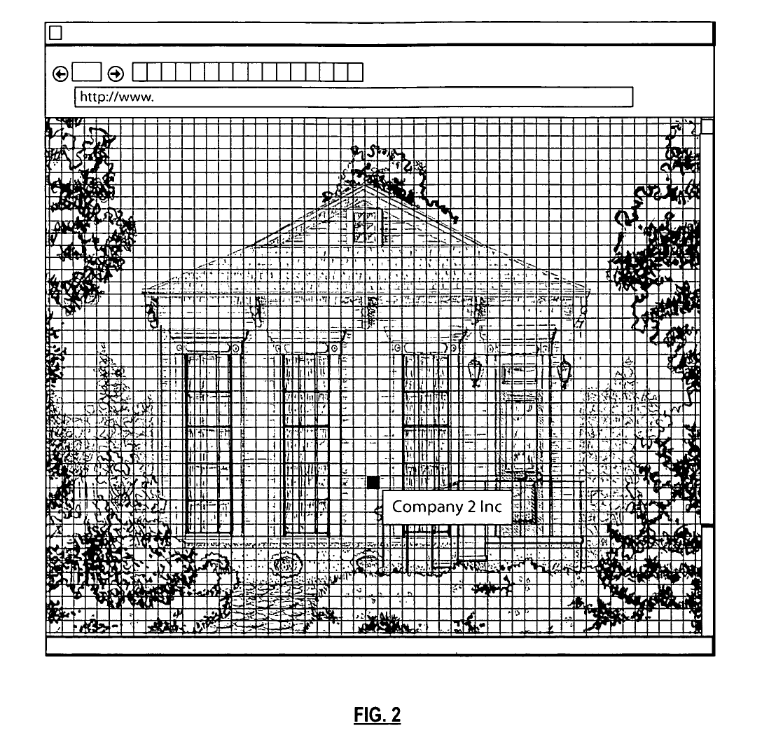

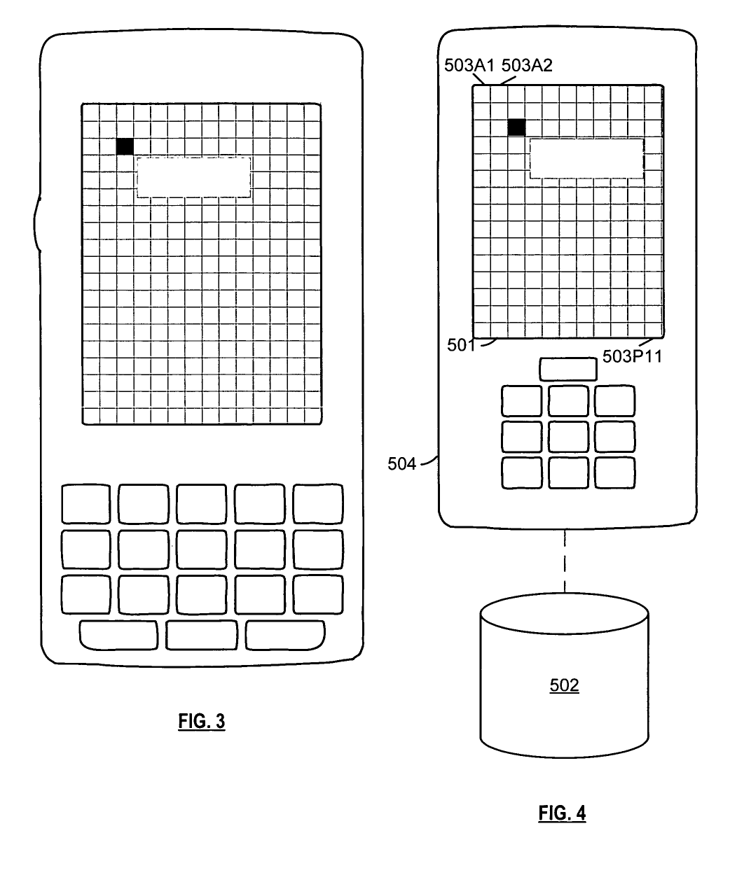

By activating (selecting) a specific sub-area, such as by placing a pointer over the sub-areas, the entire or a part of the information associated with that sub-area is displayed onto the display. It is first determined that a sub-area is activated, and the associated information element is retrieved from the storing means. The information elements associated with the sub-areas may either be stored locally in the device having the display or in a remote database. When the information element is retrieved, the entire information element or a part thereof is presented over the picture that is divided into the sub-areas. Thus if the pointer is conveyed over the display, information elements associated with the sub-areas, over which the pointer is conveyed, will be shown over the picture displayed in the display. Each information element may be visualized for a predetermined time, for example, as long as the associated sub-area is activated, or as long as the associated sub-area and a subsequent sub-area is activated. This is illustrated in FIGS. 1-4. FIGS. 1-2 show a computer screen wherein the area of the picture disclosed on the screen is divided into sub-areas as illustrated on the grid on the picture. Two different sub-areas on FIGS. 1 and 2 are activated by means of a pointer such as a mouse, pen or finger. FIGS. 3-4 illustrate mobile terminal displays also having the area of the picture disclosed on the screen divided into sub-areas as illustrated by the grid on the screen picture. That implies that it is possible to get access to tens of thousands of information elements via an ordinary computer screen without changing the picture on the screen. In addition, embodiments of the present invention can make it convenient for a user to search among a great amount of information on a very limited area such as on a display on a handheld mobile terminal.

As explained above, information elements such as company name, phone number, links, pictures, etc. may be stored in a database. When a user opens a website via, for example, a computer or a mobile terminal, the pattern is loaded on the picture disclosed on the screen. The user typically uses a pointer such as a mouse, stylus pen, finger, or a navigation tool such as a jog or another suitable means for activating the different sub-areas marked by the pattern. When the pointer is conveyed over a sub-area the entire information element or a part thereof is visualized. For example, a new window may be opened to visualize the entire or a part of the information element. If the database comprises company related information, only the company name may be visualized when the pointer is conveyed over the sub-area. By further activating the sub-area, e.g. by a mouse click (actuation), additional company information may be visualized.

One advantage of embodiments of the present invention is that a great amount of information can be accessible by only conveying a pointer over the display. Theoretically, a computer screen with a resolution of 1 024×768 pixels can provide access to 768432 squares (1×1 pixel), 196 608 squares (2×2 pixels) or 49 152 squares by using squares of 4×4 pixels. Corresponding number of squares in a display of a mobile terminal are 76 800 (1×1 pixels), 19 200 (2×2 pixels) and 4 800 (4×4 pixels) and 768 (10×10 pixels) and 192 (20*20 pixels)

A further advantage is that the methods can make it possible to create new games, competitions and lotteries wherein the searching itself in a great amount of information is an element of the competition.

Methods according to the present invention may be suitable for any of a variety of applications requiring fast access to great amounts of information.

The sub-areas may be provided with different indicators indicating different properties of the associated information such as if the information is new or old, or if the information begins at a certain letter. These indicators (i.e. color, sound, motion) can be used to find information having certain properties. Examples of how the indicators may by used are:

To identify information types. An example is that company names beginning with “A” are presented in a first color and company names beginning with “B” are presented in a second color. These colors may affect or override content displayed over the sub-areas. It is also possible to only use a special presentation the first sub-area for company names beginning with “A” and so on in an ordered view of sub-areas. The result is a grid view with a few highlighted squares delimiting regions of company names beginning with the same letter of the alphabet.

To identify information relating to a certain geographical area. An example is that a sound is utilized to identify the area. A voice may say “China” when the pointer points to companies located in China.

To identify updated information. A black square may imply that the information associated with that square is not changed since a predefined time while a red square may imply that the information associated with that red square is new and/or updated.

Moreover, the sub-areas may be divided into different groups, such that information associated with sub-areas belonging to a first group is loaded from storing means located at a remote location from the device having the display to the storing means associated to the device having the display at a first time while information associated with sub-areas belonging to a second group is loaded from storing means located at a remote location from the device having the display to the storing means associated to the device having the display at a second time.

Further, the associated information element may be hierarchically arranged, meaning that the sub-areas may be associated to a first set of information elements relating to different geographical areas. When selecting a geographical area, such as Sweden, a further set of information elements relating to regions in Sweden is associated to the sub-areas. When a region is selected a yet further set of information elements relating to restaurants in the selected region is associated with the sub-areas, and so on.

In conjunction with games and competitions, for example, one picture will preferably be covered by the entire pattern preferably comprising a plurality of squares, wherein the squares may change during the game or competition.

Methods according to the present invention can be suitable for any of a variety of applications requiring fast access to an extensive amount of information for one user wherein the application is associated with a display. The display may be connected to, or constitute a part of, a computer (stationary PC or laptop), TV-display, display for mobile terminals and PDAs. It can be used in both multi-user applications or in applications directed to a single user.

Possible applications for methods according to the present invention are:

Management of data for fast access:
Company information, phone number, address information, name etc.
The applications may be used in a cellular phone or a PDA where the user can collect all contact information on one screen picture. Other similar applications can be to provide interfaces for a plurality of internet sites, such as in a mobile phone.
Other applications are:
   Collecting information within an area, such as collecting information about all hotels in Europe on one screen page, wherein information about one hotel is associated with a square.
   Other fields can include airlines, restaurants, car brands, insurance companies, traveling etc.
   Further variants are to collect celebrities, athletes, or the like, with information comprising links to their homepages.
      Game and Competition
The methods are also suitable to be used for applications associated with games, competitions and lotteries. A game of “concentration” is an example of a typical application that may use methods according to the present invention. By combining the principles of an existing or a new game with intelligent database technology, a huge number of interesting applications can be created.
   Marketing Activities
A company that wants to introduce a new product or service. An example is for the product to be hidden in a square selected from tens of thousands of squares wherein the company allow the customers to search among the squares for the new product.
A further variant is that the information associated with the squares is company information and a task for the employees of the companies is to find their own company among all squares.

Referring to FIG. 4, in an illustrative embodiment, a display 501 is connectable to storing means 502 for storing information divided into a plurality of information elements to be accessed. An picture area displayed on the display is divided into a plurality of sub-areas such as 503A1, 503A2 . . . 503P11 wherein each sub-area is associated with at least one of the information elements. Further associated processing means 504 adapted to load a visual pattern visually marking the sub-areas are also provided, to determine that a sub-area is being activated, to retrieve the at least one information element associated with the sub-area, and to present the information element on the display.

Further, one method according to embodiments of the present invention comprises the steps of:

1. Loading a visual pattern onto the area of the picture visually marking the sub-areas.

2. Determine that a sub-area is being activated.

3. Retrieving at least one information element associated with the sub-area.

4. Presenting at least a part of the information element onto the picture displayed on the display.

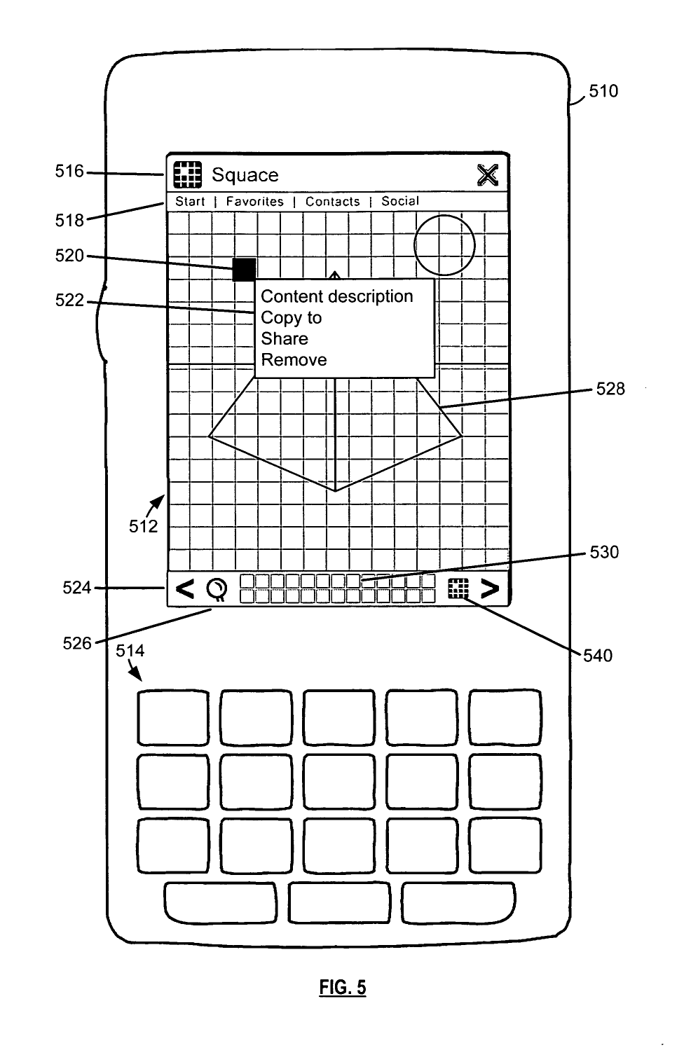

Referring to FIG. 5, an illustrative mobile terminal 510 equipped with functionality according to the invention can be a mobile telephone with a screen 512 that has one of a variety of different available screen sizes, and one or more user input devices 514, such as a keypad, a joystick, or a touch screen capability. The screen can display a number of sub-areas on a regular grid, such as a square grid. Content 528, such as one or more still or animated images, is superimposed on this grid.

Lines defining the grid are preferably evenly spaced horizontally and vertically, although grids that are only evenly spaced in one direction or even non-repetitive, completely irregular, and/or interrupted could also be employed. The grid pattern is preferably based on right angles, but grids based on triangles, rhombuses, hexagons, ovals, curved lines, or other shapes may also be used. There is generally no relationship between the visual composition of the content and particular sub-areas, except that some minor or coincidental relationship may exist in some cases. Some of the squares may also be highlighted in such as way as to affect or obscure parts of the content, as presented above.

Superimposition of content on the grid allows the content to be seen at the same time as the grid is available, but the grid may or may not be visible. In the illustrated embodiment, the grid is shown at the same time as the content, by virtue of the fact that single-pixel black grid lines effectively cut through the content. But other ways of visually dividing up the screen could also be employed, such as faint lines, broken lines, lines of other colors, dots, shadow-rendering effects, or color effects. Grid display could also be made conditional on the actuation of a pointing device or the presence of a stylus (“auto-hide”), or it could be only displayed in the vicinity of the stylus or some other portion of the screen. And if fewer than all of the sub-areas are required for the number of links for the page, only these need to be displayed. Sub-areas can be of any size.

The screen can also display other user interface elements outside of the grid, such as a home and settings icon 516, a tab bar 518, a return to home icon 540, a search control 526, and a temporary storage area 530 equipped with a scroll control 524. The home and settings icon allows the user to access a settings menu that allows him or her to customize the terminal's user interface, such as by selecting the sub-area size or the overlapping content 528. The tab bar includes one or more tabs that can be programmed to perform functions, such as navigation functions. The return to home bar is a control that causes the terminal to return to a home state. The search control allows the user to access a search screen or dialog that can enable him or her to search within the sub-areas and/or in other locations. The temporary storage area temporarily stores copies of sub-areas from the main grid.

The user can select one of the sub-areas, causing it to be shown as a highlighted sub-area 520. This selection process can be different for different phones. Phones with joysticks can allow the user to steer the highlighted sub-area around the screen, for example, and phones with touch-screen capabilities can allow the user to simply select a sub-area by touching it with a stylus or finger. Phones with touch screens may also allow the user to drag the focus around the screen while dynamically placing the focus on different sub-areas.

A pop-up menu area 522 can be displayed immediately upon selection, in a manner that preferably shows an association with the selected sub-area 520. The pop-up area can include an area that displays information about content that is accessible through the sub-area, such as a content title, content description, or a sampling of the content. The pop-up area can also include menu entries for other functions that can relate to the content, such as copy, share, or remove functions.

In the illustrated embodiment, actuating the information area causes the terminal to issue a request for the content. The content returned can be any type of content, such as an image, animation, movie, sound, contact list, contact, phone number, or web page. The content returned can also employ the grid metaphor to allow the user to drill down into further layers of content.

The user can copy sub-areas to the temporary area 530, such as by selecting “copy” in the pop-up menu area 522 and then selecting a destination sub-area of the temporary area. These copied areas can then act as “favorites” that are easily accessible. They can also be copied off of the temporary area into different grids, shared with other users, or operated on in other ways.

The tabs in the tab bar 518 can be programmed to navigate to different grid interface pages, such as a start page, a favorites page, a contacts page, and a social page. These tabs can also be programmed to navigate other types of content in response to tags in the content. The departments of an on-line store or the rubrics of a newspaper, for example, could be displayed in the tabs. The user may also be able to copy or move items from one tab view to another in a manner similar to that used to manipulate temporary items. An lower left-hand corner arrow can also be provided to allow the user to navigate to subsequent grid-based pages in a series of pages.

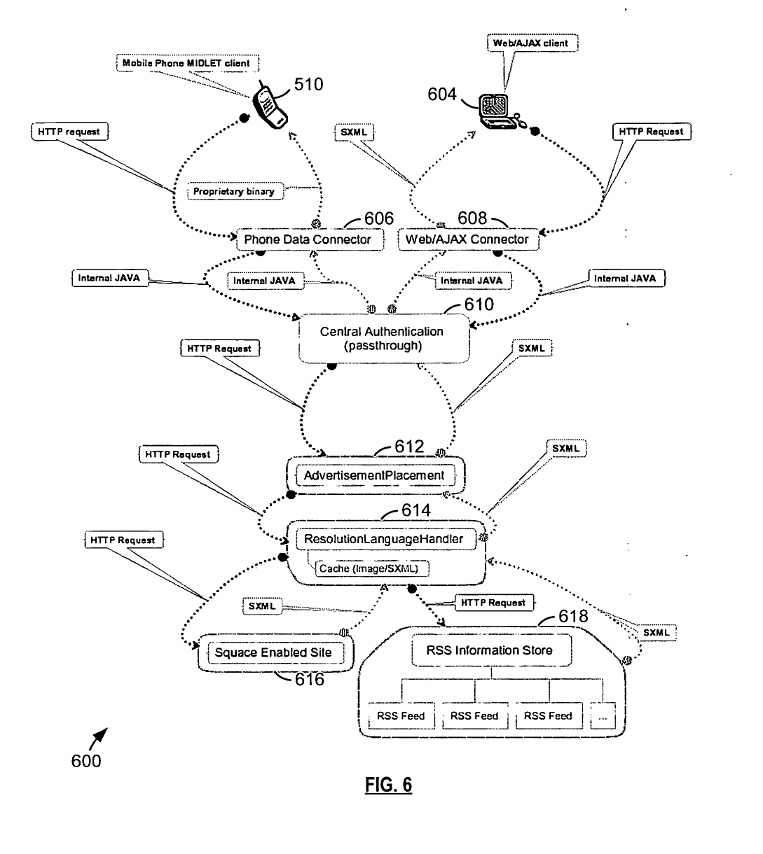

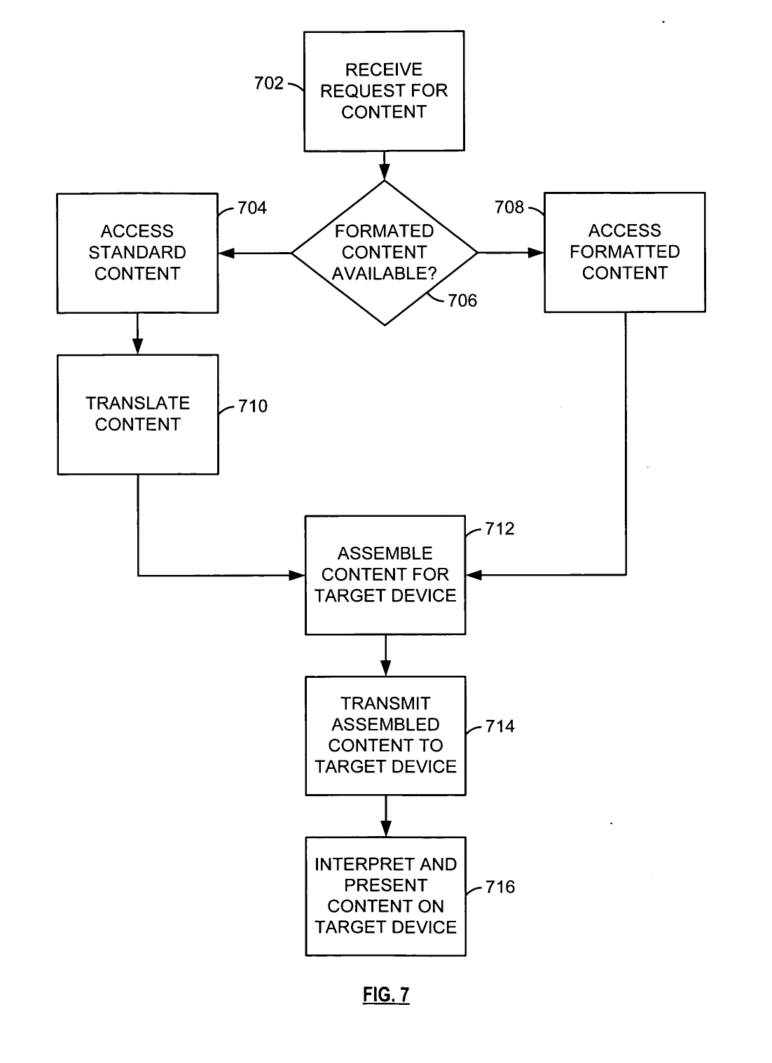

Referring to FIG. 6, when used in connection with an illustrative content delivery system 600, the mobile terminal 510 can run a client program to provide the grid-based user interface functionality. The client program preferably occupies a small amount of memory, and can be a Java ME MIDIlet application. One of ordinary skill in the art would of course recognize that other standards could be used as well, and that the grid-based user interface functionality could also be provided as native terminal code or even as dedicated terminal hardware.

The client program can communicate through a telephone network connector 606 to a central authentication module, which only passes requests from registered users of the content delivery system 600. The central authentication module can be in turn connected a content manager 614 through an optional advertisement placement module 612. The content manager can be connected to content sources, such as sources of grid-based content or RSS content, and preferably includes a database for caching at least some of this content.

The illustrative content delivery system 600 can also service other types of terminals, such as computers running full-function web browsers. In the illustrative embodiment, the system interacts with web browsers using the Asynchronous JavaScript (Ajax) technique through a web connector. But one of ordinary skill in the art would recognize that other techniques could also be used. One of ordinary skill would also recognize that the system diagram shown in FIG. 6 is illustrative only and that it is also possible to combine, redistribute, or even omit functions for the various modules to achieve a different breakdown.

In operation, referring to FIGS. 5-7, when the user actuates one of the squares (e.g., 520), the client program running on the mobile terminal 510 issues an HTTP request identifying content to be retrieved. This request is received (step 702) and authenticated by the central authentication module and is then passed on to the content manager 614.

The content manager 614 replies to the request using a special-purpose message format with grid-handling capabilities, such as SXML™. If pre-formatted content is available, the content manager can directly access this content (step 708). If it is not available, other standard content, such as RSS content, can be accessed (step 704) and translated into the special-purpose message format (step 710).

The content manager 614 then assembles the content for the target device (step 712). This involves determining attributes of the device, such as screen size, and selecting appropriate versions and/or appropriate amounts of the content. Smaller screen sizes will use smaller grids, fewer tabs, and smaller image versions, for example. To speed up this operation, commonly accessed content is preferably retrieved in advance and preprocessed to be compatible with different types of mobile devices. The content manager will then only need to retrieve the appropriate content from the database in response to a request. Supporting multiple screen sizes not only allows the content delivery system 600 to support users of different models of phones, but it also allows individual users to access their personalized pages with different devices.

The advertisement placement module can add one or more advertisements to the reply, and these advertisements can be content-specific, based on the original HTTP request. The reply can then be forwarded to the requesting mobile terminal (step 714). The client program running on the terminal interprets the reply upon receipt and presents the corresponding content on the mobile device screen (step 716).

The content delivery system 600 employs a proxy between content providers that uses a grid-enabled message format, such as an XML-based document standard. In the illustrated embodiment, the proxy is provided at no charge to both end users and content providers. The user simply creates an account and downloads the client program into his or her terminal. In the case of a mobile phone, the download can take place through a telephone network.

The illustrated system allows for both registered and unregistered content providers. Registered content providers supply a link to their hosted content on a web server, and are provided with a web-based client to test their content in the grid-enabled format. Once a registered content provider is satisfied with his or her content, the proxy can be allowed to access it to satisfy user requests. Unregistered content providers can be supported by retrieving and translating content, such as RSS content, from the providers' ordinary web pages.

Resources such as grids, texts, or images are all represented in the content delivery system 600 by a URI. The URI is an Internet address, that is run through the proxy for caching and format adjustments.

The XML document structure for the grid-enabled format includes the following tags:

<SquaceML>

SquaceML™ is the root element and has the following two tags:
head, contains information about all header elements.
body, contains information about the grid or a displayable information pane.
   <site>

The site tag is located under the head tag, and has iconimage and rootlink subtags:
Iconimage is a reference to the rectangular icon image of the site, shown in the upper left corner of the application.
The rootlink refers to the proxy internal address of the root of the current site.
   <iconimage>

The iconimage tag has the following attributes:
src referring to the source address of the icon image.
href referring to where the icon links. If href is left blank, the icon does not link.
alt holds the tooltip content of the icon image.

The use of these tags is illustrated in the following example:

```
  <?xml version = “1.0” encoding = “UTF-8” standalone= “yes”?>
  <!DOCTYPE html PUBLIC “-//OMA//DTD XHTML Mobile 1.0
Squace//EN” “http://www. squace .com/tech/DTD/xhtml-sq
uace- 10 .dtd”>
  <squaceml>
```

<head>

<title>Test
page</title>
<site>

<iconimage src=“/icon. png” href=“/index.jsp” alt=“This is a

yellow box” />

<rootlink>http://www.somecompany.com/squace/</rootlink>

</site>

</head>

</squaceml>

<tablist>

The tablist tag is located under the head tag, and describes the content of the tabset at the top of the application.
tab, one or more tab-elements.
   <tab>

The tab tag holds its title as its content and has the following attributes:
text, holding the plaintext textual content of the tab
link, referring to the page which the tab links to
selected, with the value true or false, denoting whether the tab should be rendered as selected. The default value is false.

The following example illustrates the use of the tablist and tab tags:

```
  <?xml version = “1.0” encoding = “UTF-8” standalone= “yes”?>
  <!DOCTYPE html PUBLIC “-//OMA//DTD XHTML Mobile 1.0
Squace//EN” “http://www. squace .com/tech/DTD/xhtml-sq
uace- 10 .dtd”>
  <SquaceML>
```

<head>
<title>Test page</title>

<tablist>

<tab text=“Main” link=“/?act=main” selected=“false” />
<tab text=“Test” link=“/?act=test” selected=“true” />

</tablist>

</head>

</SquaceML>

<squaregrid>

The squaregrid tag is located under the body tag, and has two functions: it denotes that the current page is a grid-based view and not a holder of content, and it holds the contents of the grid. Thus, a page with a squaregrid may not have any other content in its body. Its attributes are:
width, in number of squares.
height, in number of squares.
bgImage, referring to the background image of the square.
imageScaling, inherited to each square sub-tag.
   <square>

Each grid element is defined using a square-tag, with the attributes:
id, unique identifier.
title, text to be displayed in the grid hover
link, referring to the page to load when the square is clicked.
bgColor, holding its background color.
image, holding an address to its background image. The image can be rescaled by the content manager.
displayletter, (optional field) a single character shown in the square.
contentType, (optional field) a string giving a MIME type to hint the client about what kind of information will be presented after following the link.
content, (optional field) contains extra information to be displayed for a sub-area according to XHTML-MP dialect.
   <infobox>

The infobox tag contains a dialog window-style content pane. This dialog displays the article when a user has selected a microsqare.
content, contains the richtext information about the chosen subject according to dialect of XHTML-MP.

### EXAMPLE 1

The following example shows how a newspaper could be configured:

<?xml version=“1 .0” encoding=“UTF-8” standalone=“yes”?>

<!DOCTYPE html PUBLIC “-//OMA//DTD XHTML Mobile 1.0
Squace//EN” “http ://www.squace.com/tech/DTD/xhtml-squace-
10.dtd”>
<squaceml>

<head>

<site>

<iconimage tooltip=“Click to access
Aftonbladet.”

iconSrc=“/se/aftonbladet/images/aftonbladet.png” href=“
/se/aftonbladet” />

<rootlink>http://www.aftonbladet.se/squace

```
  /< /rootlink> </site>
  <title> Sportbladet< /title>
  <tablist>
```

<tab text=“News” selected=“False” link=“ /

http://www.aftonbladet.se/squace/news/”/>

<tab text=“Sports” selected=“True” link=“

http://www.aftonbladet.se/squace/sport/” />

<tab text=“Stocks” selected=“False” link=“

http://www.aftonbladet.se/squace/stock/” />

<tab text=“Buy/Sell” selected=“False” link=“

http://www.aftonbladet.se/squace/buysell/” />

</tablist>

</head>
<body>

<squaregrid

bgimage=“http://www.aftonbladet.se/squace/images/fotbollslandsla
get.jpg”>

<square

link=“http://www.aftonbladet.se/squace/sport/artikel1”
title=“Patriots Defeat Chargers”
image=“http://www.aftonbladet.se/squace/images/2.gif”
color=“#HF0000”/>

<square

link=“http://www.aftonbladet.se/squace/sport/artikel2” title=“Patriots
Win AFC Conference Championship” displayLetter=“B”
color=“#HF0000”>

<content>“<! [CDATA[<?xml version=“1 .0”
encoding=“UTF-

8 ”?><microml><body>Ny sportbar öppnar i stan . <br><img
src=“bar.gif”/></body></microml>] ]>”</content>

</square>
<square

link=“http://www.aftonbladet.se/squace/sport/artikel3”
title=“Patriots Win Super Bowl XLI” color=“#HF0000”/>

<square

link=“http://www.aftonbladet.se/squace/sport/artikel4” title=“Beijing
to Host 2008 Olympic Games” color=“#HF0000”/>

<square

link=“http://www.aftonbladet.se/squace/sport/artikel5”
title=“Vancouver to Host 2010 Olympic Games” color=“#HF0000”/>

<square

link=“http://www.aftonbladet.se/squace/sport/artikel6” title=“London
to Host 2012 Olympic Games” color=“#HF0000”/>

</ squaregrid>

</body>

</squaceml>

The resulting page shows a newspaper image displayed over a grid. Tabs are set for sections of the newspaper, and squares in the grid can be actuated to reach newspaper stories.

The content delivery system 600 can support server-side scripting. Any server-side web scripting language, such as ASP, PHP, JSP and Perl, and related techniques such as CGI, can be fully supported in the illustrated embodiment. The PHP example presented below illustrates this with a MySQL database set up as follows:

create table news (

id int not null
auto_increment, title
tinyblob,
primary key(id)

);

The following news.php code can then show the table contents in a grid-based format:

<?

$server = “testdatabase.local”;
$username = “test”;
$password = “test”;
$err = false;
mysql_connect($server,$username,$password) or $err = true;
?>
<?xml version=“ 1.0” encoding=“UTF-8” standalone⁼“yes”?>
<!DOCTYPE html PUBLIC “-//OMA//DTD XHTML Mobile 1.0
Squace//EN” “http://www. squace.com/tech/DTD/xhtml-squace- 1
0.dtd”>
<squaceml>

<head>

<title>News</title>

</head>
<body>

<squaregrid>

<?
$q = mysql_query(“SELECT id,title FROM
news”); foreach ($r = mysql_fetch_object($q)) {
?>

<square id=“<?=$r−>id?>”
link=“news_entry.php?id=<?⁼$r−

>id?>” title=“<?=$r−>title?>” /> <?
}
?>

</squaregrid>

</body>

</squaceml>

It is noted that this example does not require the programmer to pay attention to the size of the grid. Grid size is instead handled by the content manager.

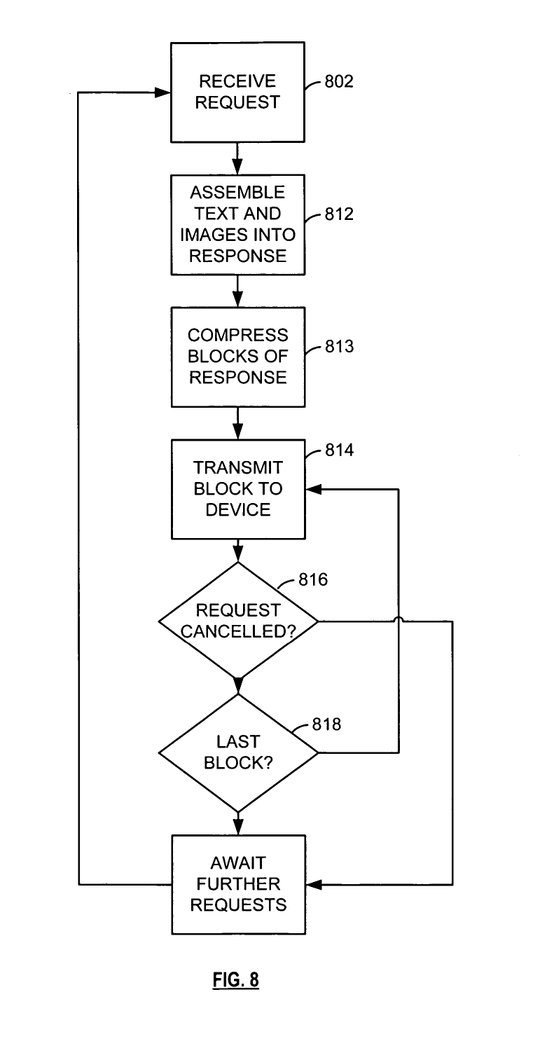

Referring to FIG. 8, in mobile networks and other applications where requests and/or bandwidth are at a premium, the reply messages can be assembled into compound messages that include disparate elements, such as text and images (step 812). This has the benefit of reducing the number of requests and replies sent through the mobile network. For example, a grid page description can be sent followed immediately by the image that is to overlap its sub-areas.

These compound messages can also be encoded according to a compressed binary format. This format has the advantage that it can send a given amount of data more quickly and therefore provide better responsiveness to the user. The compressed format can also compress the data in small blocks (step 813) and then transmit them in succession (step 814). This can allow transmission to be stopped quickly if a request is cancelled (step 816) before the last block (step 818). In the illustrative embodiment, the reply messages are compressed using a custom Lempel-Ziv compression method. Although this method employs a 32 Kbyte look-ahead buffer, it only compresses 1 Kbyte of data blocks at a time.

Another advantage is that when used over a mobile network this will reduce the number of connections set up, and thereby reduce the time used for connection set up.

While the present invention has been described with respect to particular embodiments (including certain device arrangements and certain orders of steps within various methods), those skilled in the art will recognize that the present invention is not limited to the specific embodiments described and illustrated herein. Therefore, it is to be understood that this disclosure is only illustrative. Accordingly, it is intended that the invention be limited only by the scope of the claims appended hereto.

1. A terminal operative to access information elements, comprising:
a display,
a plurality of sub-areas defined within a two-dimensional area of the display, wherein each of the sub-areas is associated with one of the information elements in a first set of the information elements, and wherein the sub-areas are organized according to a pattern, and
a content presentation area spanning over the plurality of sub-areas and operative to present content that overlaps the sub-areas.

2. The apparatus of claim 1 wherein at least some of the sub-areas remain visually differentiated despite the overlap of content in the content presentation area.

3. The apparatus of claim 2 wherein at least some of the visually differentiated areas are rendered with an attribute that corresponds to an attribute of the information elements that correspond to those areas.

4. The apparatus of claim 1 wherein the pattern is based on a grid that is regularly spaced in two directions.

5. The apparatus of claim 1 wherein the grid is a two-dimensional grid of squares.

6. The apparatus of claim 1 further including pop-up display logic operative to display information describing one of the information elements corresponding to a selected one of the sub-areas, and content display logic operative to display in the presentation area at least part of one of the information elements corresponding to an actuation one of the sub-areas.

7. The apparatus of claim 1 further including nested content display logic operative to display in the presentation area at least part of one of the information elements corresponding to an activated one of the sub-areas, wherein the displayed information element spans over a plurality of sub-areas presented within a two-dimensional area of the display, and wherein these sub-areas are organized according to a pattern, and are associated with a second set of the information elements different from the first set.

8. The apparatus of claim 1 wherein the terminal is a mobile terminal.

9. The apparatus of claim 1 wherein the terminal is a mobile telephone.

10. The apparatus of claim 1 wherein the terminal is a personal computer.

11. The apparatus of claim 1 wherein the terminal is a Personal Data Assistant (PDA).

12. The apparatus of claim 1 wherein the terminal employs a television.

13. The apparatus of claim 1 wherein the display is a touch screen and is responsive to touch-based selection of the sub-areas.

14. The apparatus of claim 1 wherein the terminal further includes a plurality of tab areas presented within the display.

15. The apparatus of claim 1 wherein the terminal further includes a temporary storage area including further sub-areas.

16. The apparatus of claim 1 wherein the terminal includes a user-downloaded program operative to define the sub-areas and present the content.

17. A terminal operative to access information elements, comprising:
a display,
a plurality of sub-areas presented within a two-dimensional area of the display, wherein each of the sub-areas is associated with one of the information elements in a first set of the information elements, and
a content presentation area spanning over the plurality of sub-areas and operative to present content that spans over the sub-areas, wherein the sub-areas are organized in a manner that is substantially independent of a composition of the content.

18. A method for making information elements available through a graphical user interface, comprising:
presenting content in a two-dimensional display area,
defining a plurality of sub-areas in the same two-dimensional area occupied by the content presented in the step of presenting, wherein the sub-areas are organized according to a pattern, and
maintaining an association between the sub-areas and the information elements.

19. The method of claim 18 further including the steps of
detecting activation of one of the sub-areas,
retrieving information for at least one information element associated with the sub-area in response to the step of detecting, and
presenting at least part of the information received in the step of receiving information in the same area used by the content presented in the step of presenting.

20. The method of claim 19 wherein the step of retrieving takes place from a remote content delivery system.

21. The method of claim 20 further including the step of acquiring the information elements by the content delivery service from the internet.

22. The method of claim 21 further including the step of translating the acquired information elements into a format that enables their display as sub-elements.

23. The method of claim 19 further including the step of encoding the information elements in a compressed binary format.

24. The method of claim 23 wherein the compressed binary format employs a block size that is smaller than its look-ahead buffer.

25. The method of claim 19 further including the step of preparing a plurality of versions of the information elements for different types of terminals having different display sizes.

26. The method of claim 25 further including the step of preparing and storing a plurality of the versions in advance of receipt of requests for the versions.

27. The method of claim 19 further including the step of making sets of user-defined associations between sub-areas and information elements for individual users available on different types of terminals having different screen sizes.

28. The method of claim 18 wherein the step of detecting activation detects selection of a sub-area and wherein the step of presenting presents information for the selected sub-area in a pop-up area.

29. The method of claim 28 further including the step of detecting actuation for the area for which selection was detected, and wherein the step of presenting presents further information for the selected sub-area in response to the actuation.

30. A method for making information elements available through a graphical user interface, comprising:
presenting content in a two-dimensional display area,
defining a plurality of sub-areas in the same area occupied by the content presented in the step of presenting, wherein the sub-areas are organized independently of a composition of the content, and maintaining an association between the each of the sub-areas and one of the information elements.

31. A memory for storing data for access by an application program being executed on a data processing system including a presentation area, comprising:
structured data stored in the memory and including:
a plurality of information resource identifiers each associated with one of a plurality of sub-areas of the presentation area that are organized according to a regular pattern, and
at least one content reference designating content to be displayed spanning over the plurality of sub areas.

32. The memory of claim 31 wherein the structured data is expressed as a tagged text document.

33. The memory of claim 32 wherein the data structure is expressed as an XML document.

34. The memory of claim 31 wherein the structured data further includes at least one pattern attribute specifier designating an attribute of the regular pattern.

35. The memory of claim 31 wherein the resource identifiers each include a unique identifier and a link.

36. The memory of claim 31 wherein the structured data further includes tab designators to define the function of tabs outside of the sub-areas.

37. The memory of claim 31 wherein the structured data further includes descriptive content associated with at least some of the resource identifiers.

38. The memory of claim 31 wherein the structured data includes a standalone structured data entity that includes resource identifiers for use independent of any screen size specification in that entity.
